(19) United States
(12) Patent Application Publication
(10) Pub. No.: US 2005/0142339 A1
(43) Pub. Date: Jun. 30, 2005

(54) Reinforced elastic laminate

(76) Inventor: Cindy Lou Price, Appleton, WI (US)

Correspondence Address: KIMBERLY-CLARK WORLDWIDE, INC., 401 NORTH LAKE STREET, NEENAH, WI, 54956, US

(21) Appl. No.: 10/748,471

(22) Filed: Dec. 30, 2003

(51) Int. Cl. B32B 7/02; B32B 27/14; B32B 1/00

(52) U.S. Cl. 428/195.1; 428/198; 442/328; 442/329; 442/394; 428/212

(57) ABSTRACT

The present invention is directed to an elastic laminate having an elastic layer and a facing layer bonded to at least one side of the elastic layer. The elastic layer has a first region having a plurality of first elastomeric fibers or filaments having a length and being prepared from a first elastomeric material and at least two second elastomeric fiber or filament having a length and being prepared from a second elastomeric material, wherein a portion of the second elastomeric fiber or filament is at least partially conjoined to a first elastic fiber or filament at one or more points along the length of each of the second and first fibers or filaments. Also disclosed is a laminate wherein the elastic layer has a second region which is devoid of the second elastomeric fiber or filament. With the two regions in the elastic layer, a laminate having different stretch and recovery characteristic in different zones.

### FIELD OF THE INVENTION

The present invention is directed to an elastic laminate having elastic properties, and uses of the elastic laminate.

### BACKGROUND OF THE INVENTION

Laminates of elastic and nonelastic materials have been made by bonding nonelastic materials to elastic materials in a manner that allows the entire composite material to stretch or elongate. These laminates can be used in garment materials, pads, diapers, training pants and other personal care products where elasticity is needed or desired.

In one such elastic laminate, a nonelastic material is joined, for example pattern bonded, to an elastic sheet while the elastic sheet is in a stretched condition. These materials are often referred to as “stretch-bonded laminates.” When the elastic sheet is relaxed, the nonelastic material gathers between the locations where it is joined to the elastic sheet. The resulting composite elastic material is stretchable to the extent that the nonelastic material, gathered between the locations where the nonelastic and elastic materials are joined, allows the elastic sheet to elongate. An example of this type of composite material is disclosed by, for example, U.S. Pat. No. 4,720,415 to Van der Wielen et al. and U.S. Pat. No. 5,503,908 to Faass et al., both hereby incorporated by reference in their entirety.

In another stretched-bonded laminate described in U.S. Pat. No. 5,385,775, to Wright, which is hereby incorporated by reference in its entirety, the elastic layer contains an anisotropic elastic fibrous web having at least one layer of elastomeric meltblown fibers and at least one layer of substantially parallel rows of elastomeric filaments autogenously bonded to at least a portion of the elastomeric meltblown fibers. This elastic fibrous web is bonded to at least one gatherable layer joined at spaced apart locations to the anisotropic elastic fibrous web, so that the gatherable layer is gathered between the spaced-apart locations. The stretch-bonded laminate described in this patent has improved tenacity in one direction.

High performance elastomers, such as Lycra®, are particularly useful in such laminates because the laminates produced using these elastomers provide good product fit over an extended use period. However, such high performance elastomers are expensive when used across the entire laminate. Further, the Lycra® polyurethane containing laminates may provide a lumpy or ruffled appearance that does not provide a flat or even surface that is discreet and invisible underneath clothing.

Lower performance elastomers, including metallocene-catalyzed olefin polymers, have also been useful because of their low cost and cloth-like appearance. Unfortunately, these less expensive elastomers do not necessarily provide high performance elastic properties and the thermoplastic laminates produced with these elastomers do not typically provide a good fit over an extended use period. As a result, products using these elastomers exhibit waist sag and poor leg fit in personal care products. Generally, there is a need for an elastic laminate for personal care products that provides high performance elastic properties at a low material cost and improved material aesthetics properties.

### SUMMARY OF THE INVENTION

The present invention is directed to an elastic laminate having an elastic layer and a facing layer bonded to at least one side of the elastic layer. The elastic layer has a first region having a plurality of first elastomeric fibers or filaments having a length and at least one second elastomeric fiber or filament having a length, wherein the second elastomeric fiber or filament is at least partially conjoined to a first elastomeric fiber or filament at one or more points along the length of each of the second and first elastomeric fibers or filaments. The conjoined elastomeric fibers and filaments reinforce each other thereby improving the elastic properties of an elastic laminate as compared to elastic laminates prepared from an elastic layer without conjoined filaments. In the practice of the present invention it is desired, but not required, that the second elastomeric fibers or filaments contain a high performance elastomer, such as Lycra® and the first elastomeric fibers of filament contain a less high performance fibers or filaments, such as elastomeric block copolymers or metallocene catalyzed polyolefins

In a further embodiment of the present invention, an elastic laminate having different elastic properties in different elastic regions is disclosed. In a first region, the elastic laminate has elastic layer having a plurality of first elastomeric fibers or filaments having a length and at least one second elastomeric fiber or filament having a length, wherein the second elastomeric fiber or filament is at least partially conjoined to a first elastic fiber or filament at one or more points along the length of each of the second and first fibers or filaments. In the second region, the elastic layer contains less of the second elastomeric fibers or filaments per linear inch in the cross-machine direction than the first region. As a result, the region of the laminate containing conjoined fibers and/or filament has a different elastic properties as compared to the elastic properties of the second region. Desirably, in a second region, the elastic layer is essentially devoid of the second elastomeric fiber or filaments.

Additionally, the present invention provides for personal care products using the elastic laminate described above.

### BRIEF DESCRIPTION OF THE DRAWINGS

FIG. 1 shows a cross-section in the cross-machine direction of a laminate of the present invention.

FIG. 2 shows a cross-section in the cross-machine direction of a laminate of another embodiment of the present invention.

FIG. 3 shows a schematic of a method of producing an elastic laminate of the present invention.

FIG. 4 shows a schematic of a different method for producing an elastic laminate of the present invention.

### DEFINITIONS

As used herein, the term “comprising” is inclusive or open-ended and does not exclude additional unrecited elements, compositional components, or method steps.

As used herein, the term “consisting essentially of” does not exclude the presence of additional materials which do not significantly affect the desired characteristics of a given composition or product. Exemplary materials of this sort would include, without limitation, pigments, antioxidants, stabilizers, surfactants, waxes, flow promoters, particulates and materials added to enhance processability of the composition.

As used herein, the term “conjoined” is used herein to mean to touch, to meet or overlap.

As used herein, the phrase “essentially devoid of the second elastomeric fibers or filaments means that there are less than 1 of the second elastomeric fibers or filaments per a given 2 inches of width in the cross-machine direction.

The term “elastic” is used herein to mean any material which, upon application of a biasing force, is stretchable in at least one direction, that is, elongatable at least about 30 percent (i.e., to a stretched, biased length which is at least about 130 percent of its relaxed unbiased length), and which, will recover at least 50 percent of its elongation upon release of the stretching, elongating force. A hypothetical example would be a 1.0 inch (2.54 cm) sample of a material which is elongatable to at least 1.50 inches (3.8 cm) and which, upon being elongated to 1.50 inches and released, will recover to a length of not more than 1.25 inches (3.13 cm). Many elastic materials may be elongated by much more than 50 percent (i.e., much more than 150 percent of their relaxed length), for example, elongated 100 percent or more, and many of these will recover to substantially their initial relaxed length, for example, to within about 105 percent of their original relaxed length, upon release of the stretching force.

The term “nonelastic” as used herein refers to any material which does not fall within the definition of “elastic,” above, including extensible materials.

The terms “recover” and “recovery” as used herein refer to a contraction of a stretched material upon termination of a biasing force following stretching of the material by application of the biasing force. For example, if a material having a relaxed, unbiased length of 1.0 inch (2.54 cm) is elongated 50 percent by stretching to a length of 1.5 inches (3.8 cm) the material would be elongated 50 percent or 0.5 inch (1.27 cm) and would have a stretched length that is 150 percent of its relaxed length. If this exemplary stretched material contracted, that is recovered to a length of 1.1 inches (2.8 cm) after release of the biasing and stretching force, the material would have recovered 80 percent or 0.4 inch (1.0 cm) of its 0.5 inch (1.27 cm) elongation. Recovery may be expressed as

$$\% Recovery = \frac{( maximum stretch length - final sample length )}{( maximum stretch length - initial sample length )} \times 100$$

The term “machine direction” as used herein refers to the direction of travel in which fibers/filaments are deposited during formation of the elastic layer.

The term “cross-machine direction” as used herein refers to the direction which is perpendicular to the machine direction defined above.

The term “stretch-to-stop” as used herein refers to the ratio determined from the difference between the unextended dimension of a composite elastic material and the maximum extended dimension of a composite elastic material upon application of a specified tensioning force and dividing that difference by the unextended dimension of the composite elastic material. If the stretch-to-stop is expressed in percent, this ratio is multiplied by 100. For example, a composite elastic material having an unextended length of 5 inches (12.7 cm) and a maximum extended length of 10 inches (25.4 cm)upon applying a force of 2000 grams has a stretch-to-stop (at 2000 grams) of 100 percent. Stretch-to-stop may also be referred to as “maximum non-destructive elongation”. Unless specified otherwise, stretch-to-stop values are reported herein at a load of 2000 grams.

As used herein, the term “nonwoven web” means a web having a structure of individual fibers or threads which are interlaid, but not in an identifiable, repeating manner. Nonwoven webs have been, in the past, formed by a variety of processes such as, for example, meltblowing processes, spunbonding processes and bonded carded web processes.

As used herein, the term “autogenous bonding” means bonding provided by fusion and/or self-adhesion of fibers and/or filaments without an applied external adhesive or bonding agent. Autogenous bonding may be provided by contact between fibers and/or filaments while at least portions of the fibers and/or filaments are semi-molten or tacky. Autogenous bonding may also be provided by blending a tackifying resin with the thermoplastic polymers used to form the fibers and/or filaments. Fibers and/or filaments formed from such a blend can be adapted to self-bond with or without the application of pressure and/or heat. Solvents may also be used to cause fusion of fibers and filaments which remains after the solvent is removed.

As used herein, the term “fiber” includes both staple fibers, i.e., fibers which have a defined length between about 19 mm and about 60 mm, fibers longer than staple fiber but are not continuous, and continuous fibers, which are sometimes called “substantially continuous filaments” or simply “filaments”. The method in which the fiber is prepared will determine if the fiber is a staple fiber or a continuous filament.

As used herein, the term “meltblowing” or “meltblown” refers to fibers formed by extruding a molten thermoplastic material through a plurality of fine, usually circular, die capillaries as molten threads or filaments into converging high velocity heated gas (e.g., air) streams which attenuate the filaments of molten thermoplastic material to reduce their diameters. Thereafter, the meltblown fibers are carried by the high velocity gas stream and are deposited on a collecting surface to form a web of randomly dispersed meltblown fibers. Such a process is disclosed, for example, in U.S. Pat. No. 3,849,241 to Butin, which is hereby incorporated by reference in its entirety. Meltblowing processes can be used to make fibers of various dimensions, including macrofibers (with average diameters from about 40 to about 100 microns), textile-type fibers (with average diameters between about 10 and about 40 microns), and microfibers (with average diameters less than about 10 microns). Meltblowing processes are particularly suited to making microfibers, including ultra-fine microfibers (with average diameters of about 3 microns or less). Meltblown fibers may be continuous or discontinuous, and are generally self bonding when deposited onto a collecting surface.

As used herein, the term “spunbond web” or “spunbond” refers to a nonwoven web prepared from small diameter fibers of molecularly oriented polymeric material. Spunbond fibers may be formed by extruding molten thermoplastic material as filaments from a plurality of fine, usually circular capillaries of a spinneret with the diameter of the extruded filaments then being rapidly reduced as in, for example, U.S. Pat. No. 4,340,563 to Appel et al., and U.S. Pat. No. 3,692,618 to Dorschner et al., U.S. Pat. No. 3,802,817 to Matsuki et al., U.S. Pat. Nos. 3,338,992 and 3,341,394 to Kinney, U.S. Pat. No. 3,502,763 to Hartman, U.S. Pat. No. 3,542,615 to Dobo et al, and U.S. Pat. No. 5,382,400 to Pike et al. Spunbond fibers are generally not tacky when they are deposited onto a collecting surface and are generally continuous. Spunbond fibers are often about 10 microns or greater in diameter. However, fine fiber spunbond webs (having an average fiber diameter less than about 10 microns) may be achieved by various methods including, but not limited to, those described in commonly assigned U.S. Pat. No. 6,200,669 to Marmon et al. and U.S. Pat. No. 5,759,926 to Pike et al., each is hereby incorporated by reference in its entirety.

As used herein, the phrase “bonded carded web” or “bcw” refers to webs that are made from staple fibers which are sent through a combing or carding unit, which separates or breaks apart and aligns the staple fibers in the machine direction to form a generally machine direction-oriented fibrous nonwoven web. Such fibers are usually purchased in bales which are placed in an opener/blender or picker which separates the fibers prior to the carding unit. Once the web is formed, it then is bonded by one or more of several known bonding methods. One such bonding method is powder bonding, wherein a powdered adhesive is distributed through the web and then activated, usually by heating the web and adhesive with hot air. Another suitable bonding method is pattern bonding, wherein heated calender rolls or ultrasonic bonding equipment are used to bond the fibers together, usually in a localized bond pattern, though the web can be bonded across its entire surface if so desired. Another suitable and well-known bonding method, particularly when using bicomponent staple fibers, is through-air bonding.

“Airlaying” or “airlaid web” is a well known process by which a fibrous nonwoven layer can be formed. In the airlaying process, bundles of small fibers having typical lengths ranging from about 3 to about 19 millimeters (mm) are separated and entrained in an air supply and then deposited onto a forming screen, usually with the assistance of a vacuum supply. The randomly deposited fibers then are bonded to one another using, for example, hot air or a spray adhesive.

As used herein, the term “polymer” generally includes, but is not limited to, homopolymers, copolymers, such as, for example, block, graft, random and alternating copolymers, terpolymers, etc. and blends and modifications thereof. Furthermore, unless otherwise specifically limited, the term “polymer” shall include all possible geometrical configurations of the material. These configurations include, but are not limited to, isotactic, syndiotactic and random symmetries.

The term “vertical filament stretch-bonded laminate” or “VF SBL” refers to a stretch-bonded laminate made using a continuous vertical filament process, as described herein.

The term “continuous filament stretch-bonded laminate” or “CF SBL” refers to a stretch-bonded laminate made using a continuous horizontal filament process, as described herein.

The term “low tension zone” or “lower tension zone” refers to a zone or region in a stretch-bonded laminate material having one or more filaments with low elastic tension characteristics relative to the filament(s) of a high tension zone, when a stretching or biasing force is applied to the stretch-bonded laminate material. Thus, when a biasing force is applied to the material, the low tension zone will stretch more easily than the high tension zone. At 50% elongation of the fabric, the high tension zone may exhibit elastic tension at least 10% greater, suitably at least 50% greater, desirably about 100-800% greater, alternatively about 150-300% greater than the low tension zone.

The term “high tension zone” or “higher tension zone” refers to a zone or region in a stretch-bonded laminate material having one or more filaments with high elastic tension characteristics relative to the filament(s) of a low tension zone, when a stretching or biasing force is applied to the stretch-bonded laminate material. Thus, when a biasing force is applied to the material, the high tension zone will stretch less easily than the low tension zone. Thus, high tension zones have a higher tension than low tension zones. The terms “high tension zone” and “low tension zone” are relative, and the material may have multiple zones of different tensions.

The term “low stretch zone” or “lower stretch zone” refers to a zone or region in a stretch-bonded laminate material having one or more filaments with low elongation characteristics relative to the filament(s) of a high stretch zone, when a stretching or biasing force is applied to the laminate material. Thus, when the same biasing force is applied to the material, the low stretch zone will not stretch as great a distance as the high stretch zone.

The term “high stretch zone” or “higher stretch zone” refers to a zone or region in a stretch-bonded laminate material having one or more filaments with high elongation characteristics relative to the filament(s) of a low stretch zone, when a stretching or biasing force is applied to the stretch-bonded laminate material. Thus, when the same biasing force is applied to the material, the high stretch zone will stretch a greater distance than the low stretch zone.

### DETAILED DESCRIPTION OF THE INVENTION

The present invention is directed to an elastic laminate having an elastic layer and a facing layer bonded to at least one side of the elastic layer. The elastic layer has a first region having a plurality of first elastomeric fibers or filaments from a first elastomeric material, the first elastomeric fibers or filaments having a length, and at least one second elastomeric fiber or filament from a second elastomeric material, the second fibers or filaments having a length, wherein each of the second elastomeric fibers or filaments is at least partially conjoined to a first elastomeric fiber or filament at one or more points along the length of each of the second and first elastomeric fibers or filaments.

Also provided by the present invention is a laminate wherein the elastic layer has a second region in which the elastic layer in the second region contains less of the second elastomeric fibers or filaments per linear inch in the cross-machine direction than the first region. As a result, the region of the laminate containing conjoined fibers and/or filament has a different elastic properties as compared to the elastic properties of the second region. Desirably, in a second region, the elastic layer is essentially devoid of the second elastomeric fiber or filaments.

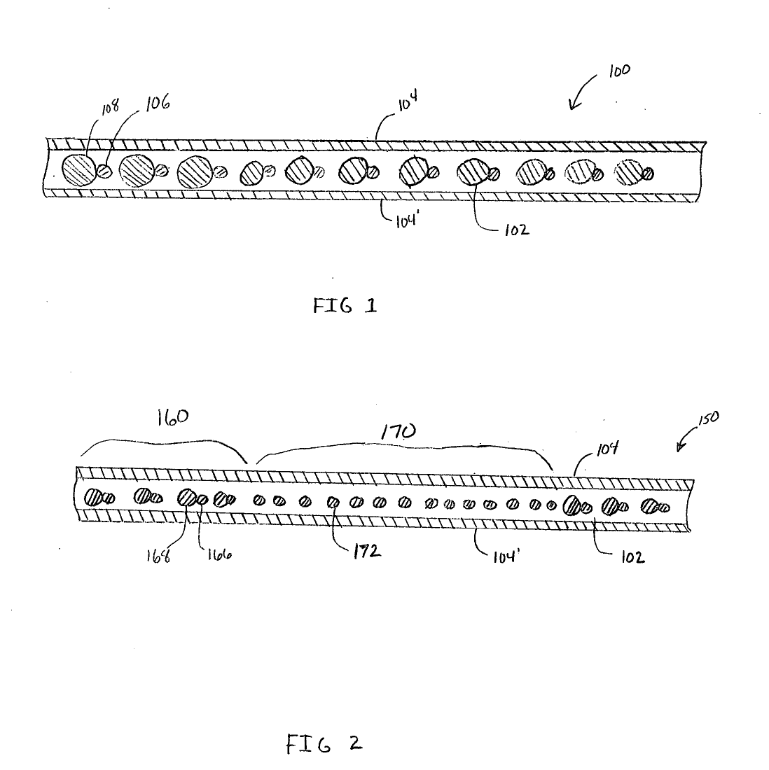

In order to obtain a better understanding of the present invention, attention is directed to FIG. 1 which shows a cross section of an elastic laminate 100 within the scope of the present invention. The laminate has an elastic layer 102 and two facing layers 104 and 104′ on each side of the elastic layer 102. It is noted that it is only necessary for one side of the elastic layer to be laminated to a facing material; however, it is desirable that both sides are laminated to the elastic material to protect the elastic layer from damage during use. As is shown in FIG. 1, the elastic layer at least two separate elastomeric fibers or filaments. The second elastomeric fibers or filaments 108 are conjoined to the first elastomeric fibers or filaments 106. That is, at least one point along the length of the first elastomeric fibers or filaments 106 and at least one point along the length of the second elastomeric fibers or filaments 108, the first and second elastomeric fibers or filaments are in contact with each other. It is further pointed out that other configurations of the first and second elastomeric fibers or filaments can be used in the present invention other than the structures shown in FIG. 1. For example, the second elastomeric fibers or filaments may have a smaller diameter that the first elastomeric fibers or filaments, the first and second fibers or filaments may be the same size. Alternatively, first elastomeric fibers or filaments may be adjacent to each other and the second elastomeric fibers and filaments could be adjacent to one another. Other configurations not specifically mentioned here may be used, so long as a portion of the second elastomeric fibers or filaments is conjoined to a first elastomeric fiber or filament. In addition, the first elastomeric fibers or filaments should have different elastomeric properties from the second elastomeric fibers or filament, for example different stretch and recovery properties. It is noted that the first elastomeric fibers or filaments could be made from the same material as the second elastomeric fiber or filaments, provided that that they have different elastomeric properties.

In another embodiment of the present invention, the elastic layer at least two separate and distinct regions. The first region has a plurality of first elastomeric fibers or filaments from a first elastomeric material, the first elastomeric fibers or filaments having a length, and at least one second elastomeric fiber or filament from a second elastomeric material, the second elastomeric fibers or filaments having a length, wherein a portion of the second elastomeric fibers or filaments is at least partially conjoined to a first elastic fiber or filament at one or more points along the length of each of the second and first elastomeric fibers or filaments. A second region is prepared from an elastomeric material and may be a filament array, fibers, a film, a foam, or ribbons produced by conventional extrusion processes. In the second region, the elastic layer contains less of the second elastomeric fibers or filaments per linear inch in the cross-machine direction than the first region. Desirably, in a second region, the elastic layer is essentially devoid of the second elastomeric fiber or filaments. Generally, it is desired from a standpoint of processing, but not required, that the second region of the elastic layer is prepared from the first elastomeric material which makes-up the first elastomeric fibers or filaments.

To gain a better understanding of this aspect of the present invention, attention is directed to FIG. 2. which shows an elastic laminate 150 within the scope of the present invention. The laminate has an elastic layer 102 and two facing layers 104 and 104′ on each side of the elastic layer 102. It is noted that it is only necessary for one side of the elastic layer to be laminated to a facing material; however, it is desirable that both sides are laminated to the elastic material to protect the elastic layer from damage during use. As is shown in FIG. 2, the elastic layer has a first region 160 which contains at least two different elastomeric fibers or filaments, each having different elastomeric properties. The second elastomeric fibers or filaments 168 are conjoined to the first elastomeric fibers or filaments 166. That is, at least one point along the length of the first elastomeric fibers or filaments 166 and at least one point along the length of the second elastomeric fibers or filaments 168, the first and second elastomeric fibers or filaments are in contact with each other. The elastic layer has a second region 170, which also contains an elastomeric material, which may or may not be present in the first elastomeric region. The second region can be a film, fibers, filaments, a foam or ribbons. Desirably, as is shown in FIG. 2, the second region contains fibers or filaments 172. The second region 170 may also contain the second elastomeric fibers or filaments 168, but if the second elastomeric fibers or filaments are present in the second region, they are present in an amount such that the elastic layer contains less of the second elastomeric fibers or filaments per linear inch in the cross-machine direction in the second region than the first region. Even more desirably, the fibers or filaments are prepared from the same elastomeric material used to prepare the first elastomeric fibers or filaments of the first region.

Additional regions can be present in the elastic layer of the present invention. For example, an additional region may be present on the other side of the second region which is similar or identical to the first region, i.e. the additional region has a first and second elastomeric fibers and filaments, a portion of which are conjoined. Further, an additional region may be prepared from a different elastomeric material or may be in a different structure; i.e. in the form of a film instead of fibers.

Suitable elastic polymers for producing the first and second elastomeric fibers or filaments include, without limitation, elastomers made from block copolymers such as polyurethanes, copolyetheresters, polyamide polyether block copolymers, ethylene vinyl acetates (EVA), block copolymers having the general formula A-B-A′ or A-B like copoly(styrene/ethylene-butylene), styrene-poly(ethylene-propylene)-styrene, styrene-poly(ethylene-butylene)-styrene, (polystyrene/poly(ethylene-butylene)/polystyrene, poly(styrene/ethylene-butylene/styrene) and the like. Examples of suitable polyurethanes include those available from E. I. du Pont de Nemours Co., Wilmington, Del. under the trade name LYCRA® polyurethane.

Suitable elastomeric resins which can be used to produce the elastomeric layer include block copolymers having general formula A-B-A′ or A-B, where A and A′ are each a thermoplastic polymer end block which contains a styrenic moiety such as a poly (vinyl arene) and where B is an elastomeric polymer midblock such as a conjugated diene or a lower alkene polymer. Block copolymers of the A-B-A′ type can have different or the same thermoplastic block copolymers for the A and A′ blocks, and the present block copolymers are intended to embrace linear, branched and radial block copolymers. Examples of such elastomeric copolymers include those known as KRATON® materials which are available from Kraton Polymers of Houston, Tex. An elastomeric nonwoven web may be formed from, for example, elastomeric (polystyrene/poly(ethylene-butylene)/polystyrene) block copolymers available from the Kraton Polymers of Houston, Tex. under the trade name KRATON® G. KRATON® block copolymers are available in several different formulations, a number of which are identified in U.S. Pat. Nos. 4,663,220 and 5,304,599, hereby incorporated by reference.

Polymers composed of an elastomeric A-B-A-B tetrablock copolymer may also be used in the practice of this invention. Such polymers are discussed in U.S. Pat. No. 5,332,613 to Taylor et al. In such polymers, A is a thermoplastic polymer block and B is an isoprene monomer unit hydrogenated to substantially a poly(ethylene-propylene) monomer unit. An example of such a tetrablock copolymer is a styrene-poly(ethylene-propylene)-styrene-poly(ethylene-propylene) or SEPSEP elastomeric block copolymer available from the Kraton Polymers of Houston, Tex. under the trade designation KRATON®.

Other suitable materials include polyamide elastomeric materials, including polyether block amides available from Ato FinaChemical Company, under the trade name PEBAX®; polyester elastomeric materials, such as those available from E. I. Du Pont de Nemours Co., under the trade name HYTREL®; single-site or metallocene- catalyzed polyolefins having a density less than about 0.89 grams/cc, available from Dow Chemical Co. under the trade name AFFINITY′®; and natural and synthetic rubbers.

Processing aids may be added to the elastomeric polymers to assist in producing films and meltblown fibers from these elastomers. For example, a polyolefin processing aid may be blended with the elastomeric polymer to improve the processability of the composition. Useful blending polyolefin materials include polyethylene, polypropylene, and polybutene, including ethylene copolymers, propylene copolymers and butene copolymers. However, these processing aids have a negative effect on the hysteresis of the base elastomer. Hysteresis is a measure of how well an elastic material retains its elastic properties over a number of stretch cycles.

The processability of the elastomers can be improved by adding a metallocene polyolefin, without negatively affecting the hysteresis of the base polymer. Such polymers have a very low or narrow polydispersity number, e.g. Mw/Mn of 4 or less, and may be made by a process referred to as the metallocene polymerization process. As taught in U.S. Pat. No. 5,853,881 issued to Estey, et al., the description of which is incorporated herein by reference, the single-site process generally uses a metallocene catalyst which is activated, i.e. ionized, by a co-catalyst. Single-site catalyzed polymers have the unique advantage of having a very narrow molecular range. Polydispersity numbers (Mw/1\4n) of below 4 and even below 2 are possible for metallocene produced polymers. These polymers also have a controlled short chain branching distribution when compared to otherwise similar Ziegler-Natta produced polymers.

The single-site catalysts are generally referred to as “single site” or “metallocene” catalysts to distinguish them from the conventional Ziegler-Natta catalysts which have multiple reaction sites. Single-site catalyzed polymers have a particular range of stretch and recovery characteristics.

The facing layer, or layers if two facing layers are present in the elastic laminate, may be a woven, a knit material, a film, a nonwoven web, paper, tissue or entangled materials, for example hydroentangled fibers in a web, such as a nonwoven web. Desirably, the facing material is prepared from a thermoplastic polymer. By selecting a woven, knit of nonwoven webs of thermoplastic polymers, the facing layer may be easily bonded to the elastic layer. Desirably, the facing layer can be a nonwoven web of fibers, such as, for example, a web of spunbond fibers, a web of meltblown fibers, a bonded carded web of fibers, a multilayer material including at least one of a spunbond layer, a meltblown layer and/or a bonded carded web. Optionally, the facing layer can be a composite material composed of a mixture of fibers and one or more other materials such as, for example, wood pulp, staple fibers, particulates or super-absorbent materials. Such mixtures may be formed by adding fibers and/or particulates to the gas stream in which meltblown fibers are carried so that an intimate entangled commingling of meltblown fibers and other materials, e.g., wood pulp, staple fibers and particulates such as, for example, hydrocolloid (hydrogel) particulates commonly referred to as superabsorbent materials, occurs prior to collection of the meltblown fibers upon a collecting device to form a coherent web of randomly dispersed meltblown fibers and other materials such as disclosed in U.S. Pat. No. 4,100,324, the disclosure of which is hereby incorporated by reference.

In order to provide strength to the elastic laminate, desirably the facing layer contains a spunbond nonwoven web. The facing layer may also be a multilayer material having two of more of the above mentioned facing layers laminated together. For example, at least one layer of a spunbond web may be joined to at least one layer of meltblown web, bonded carded web or other suitable material.

Other possible facing layers include layers which have a degree of stretchability or extensibility, such as necked spunbond nonwoven webs, which have a degree of stretch in the cross-machine direction. Various extensible body facing materials include necked or creped spunbond and sheath/core polypropylene/Kraton elastomeric bicomponent spunbond, described in U.S. application Ser. No. 10/647,008 to Rhim et al., U.S. Pat. No. 6,150,002 to Eugenio Go Verona, and U.S. application Ser. No. 10/699,193 to Sawyer et al. Various extensible garment facing materials are described in U.S. Pat. No. 6,096,014 to Haffner et al. (extensible biaxial film). Other suitable materials for use as the body facing and garment facing layers may include materials composed (entirely or partially) of elastomeric polymers that impart extensibility to the web, or in the case of nonextensible materials, such as nonwoven webs, laminates, spunbond, meltblown or bonded-carded web composed of synthetic polymer filaments or fibers, such as polypropylene, polyethylene, polyesters, or the like, perforated films, webs of natural polymer filaments or fibers such as rayon or cotton, be constructed by such a means as to allow for extensibility of the layer.

Generally, the facing layers have a basis weight of about 0. 1-4.0 osy (3.4-136 gsm), suitably 0.2-2.0 osy (6.8-68 gsm), desirably about 0.4-0.6 osy (13.5-20.3 gsm). Each facing may include the same or similar materials or different materials.

The facing layers are bonded to the elastic layer using an adhesive, for example an elastomeric adhesive such as Findley H2525A, H2525 or H2096. Other bonding means well known to those having ordinary skill in the art may also be used to bond the facing layers to elastic layer, including thermal bonding, ultrasonic bonding, mechanical stitching and the like.

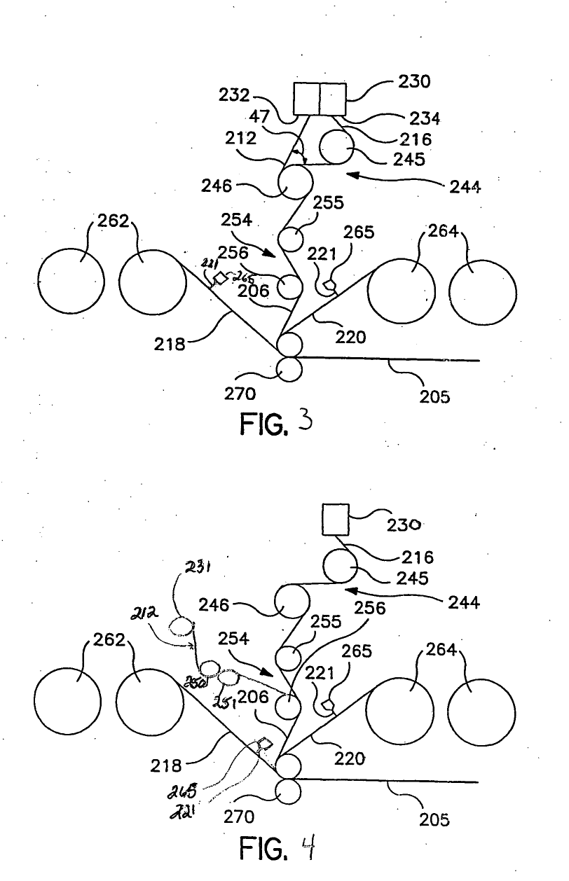

FIGS. 3 and 4 illustrate representative processes for making elastic laminate of the present invention materials. FIGS. 3 and 4 each illustrate a continuous vertical filament stretch-bond laminate (VF SBL) method.

Referring to FIG. 3, molten elastomeric material is extruded from first spin plate region 234 through spinning holes as a plurality of elastomeric first filaments 216. Similarly, a plurality of elastomeric second filaments 212 are extruded from second spin plate region 232 through spinning holes of different polymer compositions. The second filaments are aligned such that they contact the first filaments when they are deposited on the chill roll 212. The resulting web of fibers 206 has second filaments 212 which are conjoined to the first filaments 216. After extruding, first and second filaments 212 and 216 are quenched and solidified.

In one embodiment, first and second filaments 216 and 212 are quenched and solidified by passing them over a first series of chill rolls 244. For instance, second filaments 212 may be contacted with chill roll 246. First filaments 216, being prepared from a elastomeric material having a different elastomeric properties from the second filaments, may be passed over two chill rolls 245 and 246. Any number of chill rolls can be used. Suitably, chill rolls 245 and 246 have a temperature of about 40° F. to about 80° F.

After first and second filaments 216 and 212 are quenched and solidified, they are stretched or elongated. In one desired embodiment, first and second filaments 216 and 212 are stretched using a first series of stretch rolls 254. First series of stretch rolls 254 may include one or more individual stretch rolls 255, desirably at least two stretch rolls 255 and 256, as shown in FIG. 3. Stretch rolls 255 and 256 rotate at a speed greater than a speed at which chill rolls 245 and 246 rotate, thereby stretching the nonwoven fabric 206, including the zones of first and second filaments 216 and 212.

In one embodiment, each successive roll rotates at a speed greater than the speed of the previous roll. For example, referring to FIG. 3, chill roll 245 rotates at a speed “x”; chill roll 246 rotates at a speed greater than “x”, for example about “1.1x”; stretch roll 255 rotates at a still greater speed, for example about “1.15x”; second stretch roll 256 rotates at a still greater speed, for example about “1.25x” to about “2x”; and a third stretch roll 257 rotates at a still greater speed, for example about “2x” to about “7x.” As a result, first and second filaments 216 and 212 can be stretched by about 25% to about 800% of an initial length, suitably by about 200% to about 700% of an initial length.

After first and second filaments 216 and 212 are stretched, elastic series of filaments 206 is laminated to a first facing layer 218 and (alternatively) a second facing material 220. First facing layer 218 is unwound from one of the rollers 262, sprayed with a an adhesive 221 from an adhesive sprayer 265 and laminated to a first side of series of filaments 206. Second facing material 220 is unwound from one of the rollers 264 and laminated to a second side of series of filaments 206. As shown in FIG. 3, before second facing material 220 is laminated to a second side of elastic nonwoven web 206, at least a portion of second facing material 220 may be coated or sprayed with an elastomeric adhesive 221, such as Findley H2525A, H2525 or H2096, via an adhesive sprayer 265. Likewise, the laminate material is then passed through nip rolls 270 (desirably smooth or patterned calender rolls) and is relaxed and/or retracted to produce a elastic laminate. Other means for bonding the laminate material known to those having ordinary skill in the art may be used in place of nip roll 270.

FIG. 4 illustrates another VF SBL process similar to that of FIG. 4. In FIG. 4, instead of using a spinnerette 230 to supply the first and second filaments 216 and 212 to the process, a spinneret 230 and supply roll 231 are employed. The spinnerette 230 extrudes the first filaments 216 and the second filaments are supplied via a supply roll 231. Again, the first and second filaments differ from each other by the polymer compositions of the elastomeric filaments or have different stretch characteristics

Except for the use of a spinneret 230 and a supply roll 231, the processes of FIGS. 3 and 4 are similar. In either case, the first filaments 216 and second filaments 212 ultimately converge in a way such that the second filaments 212 are conjoined to the first filaments series of filaments 206. As with the first elastomeric fibers or filaments, the second elastomeric fibers or filaments are stretched using rollers 250 and 251.

Other methods of producing the elastic laminate of the present invention can be used, for example a continuous filament stretched bonded laminate process, such as the one described in U.S. Pat. 5,503,908 to Fauss et al, or U.S. Pat. 4,720,415 to Vander Wielen, both hereby incorporated by reference.

In the practice of the process of the present invention, it is desirable that the first and second fibers or filaments are brought together while one or both of the fibers are still nascent. This will allow the fibers or filaments to easily conjoin with each other. By having the second fibers or filaments conjoined to the first fibers or filaments, the conjoined fibers or filaments reinforce one another. That is, the fibers or filaments are less susceptible to breaking when they are place under tension. In addition, by using two different elastomeric materials to produce the first and second fibers and filaments, the resulting elastic laminate may have tailored properties. For example, by using a cheaper elastomeric material to produce the first fibers or filaments which has lower elastomeric properties and the second fibers of filaments which may be a more expensive elastomeric material having better elastomeric properties. The elastic laminate of the present invention will stretch until the facings layers have met their maximum extension

When the elastic laminates of the present invention have an elastic layer with at least two different regions described above, the elastic laminate may have zones which have different properties in the different zones. For example, the elastic laminate may have a zone which is a high tension zone and a zone which is a low tension zone. Typically, the zone with the second elastomeric fibers or filaments will be the high tension zone and the zone without the second elastomeric fibers and filaments will be the low tension zone. Referring to FIG. 2, region 160 is a high tension zone and region 170 is a low tension zone. Having different tension zones across the laminate allows the laminate to be used in products which require stretchability or conformability in certain areas of the product, but at the same time requires a separate area which needs to hold the product in place on the user. For example, in a personal care product such as a training pant, the waist needs to have high tension or a low stretch property to hold the training pant in place and the leg holes need to fit snugly against the user with high tension, while a lower tension or high stretch is needed to conform the training pant to the users body and allow the training pant to freely stretch as the user moves about.

The second elastomeric fibers or filaments are preferably present in the first region in an amount between 1 and 50 fibers or filaments per inch (0.4-20 fibers or filaments per cm) in the cross-machine direction of the elastic laminate. Generally, there are between 5 and 15 of the second elastomeric fibers or filaments per inch (2-6 per cm) in the cross-machine direction.

In the practice of the present invention, it is desirable that the first elastomeric fibers or filaments have a lower tension, and/or higher stretchability than the second elastomeric fibers or filaments. That is, the second elastomeric fiber or filament have a higher tension and a lower stretchability than the first elastomeric fibers or filaments at a given stretching force.

High cost and higher performance elastomeric materials may be used as the second elastomeric fibers or filaments. The resulting laminate will have properties similar to the higher performance elastomeric material rather than the lower performance elastomeric material. As a result, a significant cost saving can be realized by using the conjoined fibers or filaments of the present invention. In addition, the lower performance first fibers or filaments can help compatiblize the high performance elastomeric fibers or filaments with the facing layer. That is, less adhesive than is typically needed to laminate the facings to the high performance polymer. For example, when polypropylene facing are laminated to Lycra® elastic strands, more adhesive is needed than is needed if the elastic strands are Lycra® and a elastomeric polymer such as a Kraton® polymer. As a result, with less adhesive being used in the laminate, the overall feeling of the laminate was soft and supple, compared laminates having a higher basis weight of the adhesive.

In forming the laminates of the present invention, it is desired, but not required that the second elastomeric fibers or filaments are Lycra® polyurethane type fibers or filaments. In addition, it is desired, but not required that the first elastomeric fibers or filaments are a block copolymer material, such as a Kraton® polymer material

The laminates of the present invention can be used were elastic laminate have been previously used. Examples of products include, for example, bandages, durable wipes, durable mops, in personal care products, such as diapers and feminine napkins, protective garments such as medical and industrial gowns, caps, gloves, drapes face mask and the like, and/or agricultural products, such as a tree wrap for saplings or trees. The laminates of the present invention are especially suitable for use in garment openings for the wearer's waist, legs, arms and the like typical extend outward from the garment during use. When used in a personal care product, the laminate of the present invention provides helps seal a garment containing the laminate to a users skin, thereby preventing or reducing leakage of waste materials from inside the garment.

### EXAMPLES

### Example 1

Using a process shown in FIG. 4, a laminate was prepared. A blend of 80% by weight Kraton® G 2760, a elastomeric (polystyrene/poly(ethylene-propylene)/polystyrene/poly(ethylene-propylene)) block copolymer available from Kraton Polymers, Houston Tex., with 20% by weight of a tackifier was extruded into filaments on to a chill roll forming 12 filaments per inch in a 16 inch wide web. The elastic filaments were stretched to 250% elongation through a series of rollers. Simultaneously, Lycra® 940 strands, a polyurethane elastomer, available from E. I. du Pont de Nemours Co. are unwound and stretched to 250% elongation. The stretched Lycra® is brought into contact with the Kraton® G 2760 filaments approximately ½ inch from the edge of the Kraton filaments. The Lycra strands were placed adjacent to the Kraton® 2760 strands at a spacing of 12 filaments per ⅞ of an inch. The total width of the Lycra filaments covering ⅞ of an inch. On each side of the of Lycra and Kraton® strands a spunbond nonwoven web having a basis weight of 0.4 osy (13.5 gsm) is laminated to the Lycra and Kraton® strands by applying about 1 gsm of an adhesive on the side of the polypropylene spunbond which is brought into contact with the Lycra® and Kraton® strands. Once laminated, the laminate is relaxed and rolled.

The tension of the laminate in different regions is measured. The laminate is cut into 3 inch by 8 inch samples and the tension was measure using a BT Instron tester. In the region where the Lycra filaments are present, three different samples where prepared for testing. The tension in each of the samples at a 90% elongation was measured to be 680 grams, 720 grams, and 710 grams. The tension was also measured in the region where no Lycra strands are present. The tension in these three area measured to be 460 grams, 470 grams and 470 grams. As can be seen, the regions of the laminate with the Lycra have a higher tension than the regions without the Lycra.

### Example 2

Using a process shown in FIG. 4, another laminate was prepared. A blend of 80% by weight Kraton® G 2760, a elastomeric (polystyrene/poly(ethylene-propylene)/polystyrene/ poly(ethylene-propylene)) block copolymer available from Kraton Polymers, Houston Tex., with 20% by weight of a tackifier was extruded into filaments on to a chill roll forming 12 filaments per inch in a 16 inch wide web. The elastic filaments were stretched to 275% elongation through a series of rollers. Simultaneously, Lycra® 940 strands, a polyurethane elastomer, available from E. I. du Pont de Nemours Co. are unwound and stretched to 275% elongation. The stretched Lycra® is brought into contact with the Kraton® G 2760 filaments approximately ½ inch from the edge of the Kraton filaments. The Lycra strands were placed adjacent to the Kraton® 2760 strands at a spacing of 8 filaments in a 1.25 inch region, measured in the cross-machine direction. The total width of the Lycra filaments covering 1.25 inches. A second region of Lycra filaments also stretched to 275% were placed approximately 6 inches form the 1.25 inch region. In this second region, 4 strands of Lycra were in a 0.25 inch region, measured in the cross direction. On each side of the of Lycra and Kraton® strands a spunbond nonwoven web having a basis weight of 0.6 osy (20 gsm) is laminated to the Lycra and Kraton® strands by applying about 1 gsm of an adhesive on the side of the polypropylene spunbond which is brought into contact with the Lycra® and Kraton® strands. Once laminated, the laminate is relaxed and rolled.

The tension of the laminate in different regions is measured. The laminate is cut into 3 inch by 8 inch samples and the tension was measure using a BT Instron tester. In the region where the Lycra filaments are present, six different samples where prepared for testing. Three from the region having 8 strands of Lycra and three from the region having 4 strands of Lycra. The tension in each of the samples from the region having 8 strands of Lycra measure at a 90% elongation were found to be 600 grams, 600 grams, and 590 grams. The tension in each of the samples from the region having 4 strands of Lycra measure at a 90% elongation were found to be 450 grams, 440 grams, and 440 grams. The tension was also measured in the region where no Lycra strands are present. The tension in these three area measured to be 510 grams, 500 grams and 500 grams.

A sample of the material was heated in an oven at 170° F. for 30 minutes. The samples was pulled tight until it could not be stretched any more and cut. The cut samples were viewed and little or no creep of the Lycra was observed.

While the embodiments of the invention described herein are presently preferred, various modifications and improvements can be made without departing from the spirit and scope of the invention. The scope of the invention is indicated in the appended claims, and all changes that fall within the meaning and range of equivalents are intended to be embraced therein.

1. An elastic laminate comprising
a. an elastic layer having a first region comprising a plurality of first elastomeric fibers or filaments prepared from a first elastomeric material, said first elastomeric fibers or filaments having a length and at least one second elastomeric fibers or filaments prepared from a second elastomeric material, said second elastomeric fibers or filaments having a length, wherein a portion of the second elastomeric fibers or filaments is at least partially conjoined to a first elastomeric fiber or filament at one or more points along the length of each of the second and first fibers or filaments; and
b. a facing layer bonded to at least a first side of the elastic layer.

2. The elastic laminate of claim 1, wherein the first region comprises between 1 and 50 of the second elastomeric fibers or filaments per inch in a cross machine direction which are conjoined to first elastomeric fibers or filaments.

3. The elastic laminate of claim 2, wherein the first region comprises between 5 and 15 of the second elastomeric fibers or filaments per inch in a cross machine direction which are conjoined to a first elastomeric fiber or filament.

4. The elastic laminate of claim 1, wherein the first elastomeric material comprises a polymer selected from polyurethanes, copolyetheresters, polyamide polyether block copolymers, ethylene vinyl acetates (EVA), block copolymers having general formula A-B-A′, A-B, elastomeric A-B-A-B where A and A′ are each a thermoplastic polymer end block which contains a styrenic moiety such as a poly (vinyl arene) and where B is an elastomeric polymer midblock such as a conjugated diene or a lower alkene polymer and the second elastomeric material comprises a polymer selected from polyurethanes, copolyetheresters, polyamide polyether block copolymers, ethylene vinyl acetates (EVA), block copolymers having general formula A-B-A′, A-B, elastomeric A-B-A-B where A and A′ are each a thermoplastic polymer end block which contains a styrenic moiety such as a poly (vinyl arene) and where B is an elastomeric polymer midblock such as a conjugated diene or a lower alkene polymer, and wherein the first elastomeric fibers or filaments have different elastic properties from the second elastomeric fibers or filaments.

5. The elastic laminate of claim 4, wherein the first elastomeric material comprises an elastomeric block copolymer and the second elastomeric material comprises lycra.

6. The elastic laminate of claim 3, wherein the first elastomeric material comprises (polystyrene/poly(ethylene-propylene)/polystyrene/poly(ethylene-propylene)) block copolymer and the second elastomeric material comprises lycra.

7. The elastic laminate of claim 1, wherein the elastic layer further comprises a second region comprising an elastomeric material, wherein the second region comprises fewer second elastomeric fibers or filaments conjoined to the first elastomeric fibers or filaments per liner inch in a cross-machine direction of the laminate.

8. The laminate of claim 7, wherein the second region is essentially devoid of any of the second elastomeric fibers or filaments conjoined to the first elastomeric fibers or filaments

9. The elastic laminate of claim 8, wherein the elastomeric material of the second region comprises a plurality of elastomeric fibers or filaments.

10. The elastic laminate of claim 9, wherein the elastomeric fibers or filaments of the second region comprise fibers or filaments prepared from the first elastomeric material.

11. The elastic laminate of claim 10, wherein the first region comprises between 2 and 50 of the second elastomeric fibers or filaments in the cross-machine direction conjoined to a first elastomeric fiber or filament.

12. The elastic laminate of claim 11, wherein the first region comprises between 5 and 15 of the second elastomeric fibers or filaments in the cross-machine direction conjoined to a first elastomeric fiber or filament.

13. The elastic laminate of claim 12 wherein the first elastomeric material comprises a polymer selected from polyurethanes, copolyetheresters, polyamide polyether block copolymers, ethylene vinyl acetates (EVA), block copolymers having general formula A-B-A′, A-B, elastomeric A-B-A-B where A and A′ are each a thermoplastic polymer end block which contains a styrenic moiety such as a poly (vinyl arene) and where B is an elastomeric polymer midblock such as a conjugated diene or a lower alkene polymer and the second elastomeric material comprises a polymer selected from polyurethanes, copolyetheresters, polyamide polyether block copolymers, ethylene vinyl acetates (EVA), block copolymers having general formula A-B-A′, A-B, elastomeric A-B-A-B where A and A′ are each a thermoplastic polymer end block which contains a styrenic moiety such as a poly (vinyl arene) and where B is an elastomeric polymer midblock such as a conjugated diene or a lower alkene polymer, and wherein the first elastomeric fibers or filaments have different elastic properties from the second elastomeric fibers or filaments.

14. The elastic laminate of claim 13, wherein the first elastomeric material comprises (polystyrene/poly(ethylene-propylene)/polystyrene/poly(ethylene-propylene)) block copolymer and the second elastomeric material comprises lycra.

15. The elastic laminate of claim 1, wherein the elastic layer has a first side and a second side, wherein a facing layer is bonded to the first side and second side of the elastic layer.

16. The elastic laminate of claim 7, wherein the elastic layer has a first side and a second side, wherein a facing layer is bonded to the first side and second side of the elastic layer.

17. The elastic laminate of claim 7, wherein the first region has a high tension, low stretch characteristic and the second region has a low tension, high stretch characteristic.

18. The elastic laminate of claim 14, wherein the first region has a high tension, low stretch characteristic and the second region has a low tension, high stretch characteristic.

19. A personal care product comprising the elastic laminate of claim 1.

20. A personal care product comprising the elastic laminate of claim 7.
